(19) United States
(12) Patent Application Publication
(10) Pub. No.: US 2026/0298368 A1
(43) Pub. Date: Oct. 1, 2026

(54) GATE VALVE MONITOR

(71) Applicant: FST INNOVATION PTY LTD, Balwyn North, Victoria (AU)

(72) Inventor: Shae Mete, Balwyn North, Victoria (AU)

(21) Appl. No.: 19/477,321

(22) PCT Filed: Apr. 19, 2024
(86) PCT No.: PCT/AU2024/050376

§ 371 Date: Oct. 21, 2025

(30) Foreign Application Priority Data
Apr. 21, 2023 (AU) 2023202458

(51) Int. Cl. F16K 37/00; A62C 35/68; F16K 31/50

(52) U.S. Cl. CPC F16K 37/0041; F16K 31/50; A62C 35/68

(57) ABSTRACT

A gate valve monitor is described. In one broad form, the gate valve monitor comprises an actuator accommodated inside an enclosure. The enclosure may be the valve body or a separate component. In one embodiment the gate valve monitor comprises one or more switch and an actuator, the one or more switch and actuator accommodated within an enclosure and the enclosure dimensioned to allow passage of said gate valve shaft. The actuator is operated by movement of the gate valve shaft to trigger the one or more switch. Also described are a gate valve comprising the gate valve monitor, a method of monitoring a gate valve a method of manufacturing a gate valve monitor and a kit for monitoring a gate valve.

### FIELD OF THE INVENTION

The present invention relates to a monitor for a gate valve also known as an Outside Screw and Yoke (OSY) valve. More particularly, this invention relates to a gate valve monitor comprising an actuator accommodated inside an enclosure. Advantageously, the enclosure may be dimensioned to be wholly positioned within the valve body such as, the space between valve yoke arms.

### BACKGROUND TO THE INVENTION

Fire protection systems make use of valves to isolate the fire sprinkler system within a building. The valve may be shut to stop water supply to the sprinkler system to facilitate works to the system. Some valves provide a visual indication of open or closed valve condition. A warehouse or a high-rise building typically includes about fifty (50) valves in the sprinkler and fire hydrant (standpipe) installations that are required to be electronically monitored so that an automatic alarm is generated if the valve is operated.

Both gate valves and butterfly valves are used in fire protection systems. Gate valves are preferred in some applications and indeed some regulations mandate the use of gate valves.

Various methods of electronic valve monitor devices have been utilized to prevent operation of the valve from going unnoticed or to provide a degree of tamper resistance to prevent unauthorized access to the valve such that the monitoring equipment can be defeated. Electronic valve monitoring and preventing unauthorised access is highly desirable because an arsonist may wish to close the valve to prevent the sprinkler system from extinguishing a fire. Also, maintenance personnel may seek to deliberately defeat the monitor to avoid tedious procedural requirements when conducting testing or works. The problem of defeating monitors resulting in unnoticed, inadvertent isolation of fire protection systems for extended periods is well known in the industry.

Electronic valve monitors have been commonly used in sprinkler and hydrant systems, as a way to prevent inadvertent or malicious isolation of these systems. Codes and Standards require electronic valve monitors in more and more applications in fire protection globally.

To date, two methods have been used to perform valve monitoring. These can be categorised as internal and external. For butterfly valves, internal valve monitoring is achieved by using a switch inside the gearbox of a valve. The internal switch is activated when internal components move upon operation of the valve.

Gate valves do not have a gear box, which means external valve monitoring must be used. Typically, external valve monitoring is implemented by bolting on an external switch device to a standard non-monitored valve. The external valve monitor uses a switch to detect the movement of external parts of the valve when the valve is operated.

Two classes of tamper resistance are possible with electronic valve monitors. Class B is considered Standard Security and simply requires that the valve automatically generates an alarm when the valve is operated. Class A is considered Enhanced Security which requires the same as Class B, but also requires that an alarm is automatically generated if an attempt is made to access the internals of the valve or valve monitor, or to remove the valve monitoring device itself.

Many butterfly valve manufacturers make Class B valves. All are similar and work using a simple switch activated by the mechanical movement in the gearbox. When the valve is turned, the switch is operated, and an alarm is signalled at the fire alarm control panel. The inclusion of the switches is simple and therefore Class B monitors are cost-effective but, they only provide signalling of valve operation and no tamper protection.

Class B butterfly valves can be upgraded to Class A. This conversion may be accomplished by fitting a special external electronic device and the internal switch is then not used. Two example external electronic devices are the Amtron valve monitor and the Potter valve monitor. The Amtron valve monitor requires some modification to the parent valve and increases the cost to the end user This cost can be double the cost of the valve itself. The Potter valve monitor also increases the cost and may be easily defeated by jamming the protruding lever so it is no longer activated when the valve shaft moves. These external devices are large and require careful installation and mounting. Being external, they are subject to impact, sometimes resulting in false alarms and difficulty resetting which will result in a technician service call to repair or replace the monitor.

The push for cheaper Class A devices has led to relatively low performing alternate solutions, which have been provided, in order to avoid the expense of approved Class A devices such as, the Amtron valve monitor. Some alternate solutions are not approved by appropriately recognized bodies as meeting the standards required by Class A. There are concerns about the compliance of these alternate solutions and methods have been publicly revealed to defeat these and even the approved Class A devices.

Korean patent publication 10-0702141, to Young Chul Kim, describes a conventional supervisory valve and a separate device, the subject of the application for patent, which solves the problem of drilling into the shaft to attach the magnet by attaching a removable coupling member 10, in the form of a bracket, to the shaft 4 using a bolt 18. The coupling member 10 is positioned such that when elevating member 20 travels upwards, by virtue of attachment to the shaft 4, as the shaft rises to open the valve, it will come into contact with valve 6, which depresses elevating member 20, such that magnet 40 is detected by sensor 50. A significant problem with the device disclosed in this document is, for the concept of a bracket on the valve shaft to function in the real world, the length of the gate valve shaft needs to be made longer. This device requires that a switch be clamped permanently to the valve shaft. This switch, housed on the bracket, moves up and down with the opening and closing of the valve. The bracket will eventually hit the valve body before the valve is fully shut. In real terms and for typical sizes, to make the bracket-on-shaft solution practical, the gate valve will need to be made at least 100 mm taller than it would otherwise need to be. Gate valves are already too long with their protruding stem already being something of an OHS hazard on site. In view of this potential hazard, it is undesirable to increase valve shaft length because it will put their valve at a significant disadvantage.

U.S. Pat. No. 3,606,242 to M & J VALVE CO teaches automatic valve actuation and is not related to fire monitoring. This style of gate valve is exotic and significantly expensive in relation to typical valves used in the water and fire industry. The technology described in this document is for valves that are for remote application or in highly aggressive environments. As such the housing is essentially one piece, incorporating complex geometry of embedded channels to accommodate fully hydraulic and electric componentry. It would not be commercially feasible or beneficial to adopt this valve a fire protection environment, or modify typical fire protection valves to incorporate the complex switching methods taught in this document.

AU 2022204325 to FST INNOVATION PTY LTD, is to the same inventor and applicant as this document. The two documents differ in the type of valve to which they are applied. This document is directed to gate valves, whereas AU 2022204325 is directed to butterfly valves. Gate valves and butterfly valves are often utilised in different applications. This is because a butterfly valve is not a full bore valve. That is, the fluid flow path in a butterfly valve is not entirely unobstructed. The requirement for a full bore valve may mean some applications may make it impossible to use a butterfly valve and a gate valve may be mandated by implementing regulations.

Butterfly valves, such as that shown in AU 2022204325, have effective enhanced security solutions available. The advantageous increased degree of security achieved by AU 2022204325 is achieved via the gearbox of the butterfly valve. Gate valves do not use gearboxes. Also, butterfly valves are not full bore valves, because the valve member, even in the open position, still obstructs some fluid flow.

U.S. Pat. No. 4,696,325 teaches the application of external magnetic reed switches, which while relatively cost effective, the technology suffers from the same weakness as KR 100702141, in that magnetic sensors are able to be influenced negatively by external magnetic fields. According to U.S. Pat. No. 4,696,325, a magnet 39 is positioned on piston 34, which is fixed to rod 25. The opening and closing of gate 16, appears to be hydraulically actuated by fluid flowing through ducts 41 and 42. The magnetically operated electrical switches 51, 57 are accommodated in bores 46 and 47. The non-magnetic walls separating the cylindrical bore 24 from the bores 46 and 47 are described as being relatively thin to allow magnet 39 to trigger switches 51, 57. Column 4, at lines 22 to 53 and illustrated in FIGS. 4 and 5, describes a collar 58 mounted on the helical groove of the stem 57 of the valve. D4 requires that the collar be “a highly ferro magnetic material” (column 4 at line 40). As stated in D4, a sensor 11 is attached to the indicator 51 so as to sense the position of the collar 58 and when the collar moves to the gate closed position, then the sensor 11 provides the alarm signal (column 4 at lines 41 to 42). The device of D4 is prone to tampering, as the collar can be simply moved up and down the stem 57, or another magnetic component can be used to trigger the alarm.

There remains a need for alternative mechanisms to monitor valves and/or provide alternative anti-tamper mechanisms.

The reference to any prior art in this specification is not, and should not be taken as, an acknowledgement or any form of suggestion that the prior art forms part of the common general knowledge.

### SUMMARY OF THE INVENTION

Generally, embodiments of the present invention relate to a gate valve monitor.

In one broad form, the invention relates to a gate valve monitor comprising an actuator accommodated inside an enclosure. The enclosure may be the valve body or a separate component.

In another broad form, the invention relates to a gate valve comprising an enclosure dimensioned to be wholly positioned within the valve body such as, the space between valve yoke arms, the space enclosing the handwheel nut, or the space within the valve bonnet cover.

In a first aspect, although it need not be the only or indeed the broadest aspect, the invention relates to a gate valve monitor comprising:
one or more switch and an actuator, the one or more switch and actuator accommodated within an enclosure, the enclosure dimensioned to allow passage of said gate valve shaft; and
the actuator operated by movement of the gate valve shaft to trigger the one or more switch.

In a second aspect, the invention relates to a gate valve comprising the gate valve monitor of the first aspect.

In a third aspect, the invention relates to a method of monitoring a gate valve, the method comprising:
fitting or retrofitting a gate valve monitor to a gate valve, the gate valve monitor comprising one or more switch and an actuator, the one or more switch and the actuator accommodated within an enclosure, the enclosure dimensioned to allow passage of said gate valve shaft, wherein the actuator is operated when the gate valve shaft moves to trigger the one or more switch.

In a fourth aspect, the invention relates to a method of manufacturing a gate valve monitor, the method comprising:
providing one or more switch and an actuator, the one or more switch and the actuator to be accommodated within an enclosure, the enclosure dimensioned to allow passage of said gate valve shaft; and
inserting the one or more switch and the actuator into the enclosure, wherein the actuator is operated by movement of the gate valve shaft to trigger the one or more switch.

In a fifth aspect, the invention relates to a kit for monitoring a gate valve, the kit comprising:
an enclosure, one or more switch and an actuator, the one or more switch and the actuator to be accommodated within the enclosure, the enclosure dimensioned to allow passage of said gate valve shaft;
wherein the actuator is operated by movement of the gate valve shaft to trigger the one or more switch.

In a sixth aspect, the invention relates to a method of monitoring a gate valve, the method comprising fitting or retrofitting the valve monitor of the first aspect to the gate valve.

In a seventh aspect, the invention provides a method of preventing unauthorised opening or closing of a gate valve, the method comprising fitting or retrofitting the valve monitor of the first aspect to the gate valve.

According to any one of the third, sixth or seventh aspects, the fitting or retrofitting may comprise fastening the gate valve monitor to the gate valve with one or more fastener. The one or more fastener may attach through one or more valve body fastener holes. The valve body fastener holes may be disposed in a valve body or yoke arms. The one or more fastener may also attach through one or more enclosure fastener holes.

In one embodiment, the gate valve monitor of the invention is of particular advantage because no drilling or modifications are required to the valve at all in order to install the monitor.

In one embodiment of any one of the above aspects, the one or more switch and the actuator are dimensioned to be accommodated within the enclosure. The one or more switch and the actuator may be dimensioned to be accommodated with the enclosure when in use.

In one particular embodiment of any one of the above aspects, the enclosure is the valve body. That is, the valve body may form the enclosure accommodating the one or more switch and the actuator. The valve body may comprise a port and a channel to receive one or more connection to the valve monitor. The one or more connection may be a wired connection or wireless connection and may provide at least one of electronic communication, an antenna and power. The port and channel may be disposed above or below the yoke arms.

In another particular embodiment of the any one of above aspects, the actuator is wholly accommodated within the enclosure. No part of the actuator may extend outside the enclosure. The actuator may comprise a single integer or single component, the single integer or single component may comprise a mechanical integer or mechanical component.

In one embodiment, the actuator comprises a magnet. The operation of the actuator by the movement of the gate valve shaft may move the magnet to trigger a magnetically operated switch, such as a reed switch or an LED to trigger a light sensor, or metallic body to trigger a proximity sensor.

In another embodiment of any one of the above aspects, the enclosure is a separate component to the valve body. The enclosure may be dimensioned to be wholly positioned within the valve body. No part of the enclosure may extend outside the valve body. The enclosure may be dimensioned within a space between valve yoke arms, the space enclosing the handwheel nut, or the space within the valve bonnet cover. In one particular embodiment, in use, the enclosure does not protrude outside the valve body.

In one embodiment of any one of the above aspects, the enclosure may comprise two external case components. The two external case components may join together such as, with one or more fastener. The one or more fastener may comprise complementary fastening components on the two external case components.

In another embodiment of any one of the above aspects, on or both of the external case components may comprise one or more walled partition for seating the one or more switch. The walled partition may be formed by a partition wall and a well.

According to any one of the above aspects, the two external case components may comprise a case and a lid. The case may comprise the one or more walled partition for seating the one or more switch.

In one embodiment of any one of the above aspects, the case comprises an external wall. The walled partition may be comprised on the case. The case may comprise a case fastener.

In another embodiment of any one of the above aspects, the lid comprises a lid external wall. The lid may comprise a side wall. Channel walls may extend from the side wall. The channel walls may extend on opposing sides of the lid. The opposing channel walls may form a lid shaft channel. The lid may comprise a lid fastener. The lid fastener may fasten to the complementary case fastener to shut the enclosure. The shutting of the enclosure may be a locking or a one-way shutting. The locking or one-way shutting may require a tool to unlock or open the enclosure. The walled partition may be comprised on the lid.

In yet another embodiment of any one of the above aspects, the enclosure may comprise a spacer housed in the enclosure. The spacer may be positioned between the lid and the case. The spacer may comprise a spacer body. A spacer wall may extend from the spacer body. One or more column may extend from the spacer wall. The one or more column may extend on opposing sides of the spacer. The opposing columns may form a shaft channel. The enclosure may further comprise one or more switch access passage. Each of the one or more switch access passage may extend through the spacer to access the one or more switch. Each of the one or more switch access passage may extend through the spacer wall and columns.

According to any one of the above aspects, the enclosure may comprise one or more seal such as, an o-ring. The one or more seal may prevent water or dirt entering the internal space and the one or more switch. The one or more seal may seal the shaft channel and/or the port.

In another embodiment of any one of the above aspects, the spacer may be integral with the case or lid.

In another embodiment of any one of the above aspects, the spacer comprises a spacer locator for interaction with one or both of a case locator or a lid locator. The interaction of the spacer locator with one or both of the case locator and/or the lid locator may prevent or restrict relative movement.

In another embodiment the one or more switch may be activated by the unauthorized opening or closing of a gate valve or attempted removal of the valve monitor. The switch may activate a trouble alarm condition at the fire or security panel.

In yet another embodiment of any one of the above aspects, the actuator body may extend in to a groove in the gate valve shaft. The actuator may be operated by movement of the gate valve shaft which impacts the actuator body to trigger the one or more alarm switch.

In still another embodiment of any one of the above aspects, the actuator may comprise an actuator body dimensioned to extend into a groove in said gate valve shaft. The movement of the gate valve shaft may impact the actuator body which activates the one or more alarm switch. The actuator body dimensioned to extend into the groove may comprise a shape complimentary to the groove. The actuator body may comprise a contact surface. The contact surface may comprise a curved or convex shape. The contact surface may comprise a rolling element to reduce friction and load during movement.

In one particular embodiment, the actuator body may comprise a plate. A protrusion may be disposed on the plate, the protrusion may extend into a groove in said gate valve shaft. The movement of the gate valve shaft may impact the protrusion which moves the plate to activate the one or more alarm switch. The protrusion may comprise the contact surface and comprise a shape complementary to the groove in the gate valve shaft. The gate valve protrusion may comprise a contact surface. The actuator may comprise one or more switch activator. The one or more switch activator may comprise one or more column. The one or more switch activator may comprise an activating surface to trigger the one or more switch.

In another embodiment, the actuator may comprise a bar. Part of the bar may protrude into the groove in the gate valve shaft. The movement of the gate valve shaft may impact the bar which moves the bar to activate the one or more switch. The bar may comprise the contact surface and comprise a shape complementary to the groove in the gate valve shaft. The bar may be U-shaped. The contact surface may be disposed on the middle-section of the U-shaped bar.

In another embodiment, the actuator may comprise a lever. Part of the lever may protrude into the groove in the gate valve shaft. The movement of the gate valve shaft may impact the lever which moves the lever to activate the one or more switch. The lever may comprise the contact surface and comprise a shape complementary to the groove in the gate valve shaft. The lever may comprise a cam surface which acts on a switch activator, optionally in the form of a pin. The lever may be linear. The contact surface may be disposed on a middle-section of the lever.

In another embodiment, the actuator is directly operated by movement of the gate valve or gate valve shaft. The direct operation may comprise physical impact of the gate valve shaft on the actuator. The physical impact may be on the actuator body. The physical impact may result from a sliding movement or rotation of the gate valve shaft.

In yet another embodiment of any one of the above aspects, the actuator may comprise one or more actuator locating component to interact with one or more complementary locating component. The complementary locating component may be housed on the enclosure.

In another particular embodiment of any one of the above aspects, the actuator comprises a bias. The bias may comprise a spring such as, at least one of a compression spring; a tension spring; a spring washer; and a leaf spring. The bias may hold the actuator in a non-alarm position. The bias may hold the actuator in a non-alarm position through direct contact or indirection action through an intermediate component. The intermediate component may be the switch activator, optionally the pin. When the actuator is operated by movement of the gate valve shaft, the bias may be overcome to move the actuator into an alarm position to trigger the one or more switch.

In still another embodiment of any one of the above aspects, the passage of the gate valve shaft means the gate valve shaft traverses an entire extent of the enclosure.

In another embodiment of any one of the above aspects, the one or more switch may comprise a terminal switch. The terminal switch may not be a magnetic switch. The one or more switch may be wholly located within the enclosure.

In a particular embodiment, two switches are comprised. A normal state switch may be triggered by the actuator in a normal state of the monitor. An alarm switch may be triggered by the actuator in an alarm state of the actuator. The normal state switch and the alarm switch may be on opposing sides of the enclosure.

In yet another embodiment of any one of the above aspects, the enclosure may comprise a port. The port may accommodate cabling such as, electrical cabling to provide one or both of power and communications. The port may be comprised on the case or the lid or the valve body.

In still another embodiment of any one of the above aspects, a wireless module and optionally one or both of: a battery and antenna are comprised.

According to any of the above aspects, the valve monitor may comprise an anti-tamper valve monitor. The anti-tamper valve monitor may comprise the one or more switch being activated by an attempt to tamper with or attempt to access or remove the valve monitor. The anti-tamper valve monitor may comprise the lid being dimensioned such that removal or partial removal of the lid concomitantly removes or partially removes the actuator to release contact of the one or more switch. The release of contact of the one or more switch generates an alarm signal.

In another embodiment of one of the above aspects, the removal of the lid, or the attempted movement or removal of the monitor does not activate a secondary ‘tamper switch’ but instead activates an one or more switch used to trigger an alarm which activates when the valve is operated. Such gate valves are required to be tested routinely and therefore, by testing the one or more switch the ‘tamper’ functionality is also tested. Alternatively, where secondary tamper switches are used to monitor tamper or removal of the lid, no means of easily and routinely testing this tamper switch or circuit is possible.

According to any one of the above aspects a wireless module, battery and antenna are incorporated within the enclosure to provide anti-tamper protection.

According to any one of the above aspects, the gate valve may be a gate valve for or when used in a fire protection system, such as a fire sprinkler system,

According to any one of the above aspects, the movement of the gate valve shaft may comprise a sliding movement or a rotation. The sliding movement or rotation may be to open or close the gate valve.

Further aspects and/or features of the present invention will become apparent from the following detailed description.

According to any one of the above aspects the valve and valve monitor are for a fire protection system and/or a fire sprinkler system.

### BRIEF DESCRIPTION OF THE DRAWINGS

In order that the invention may be readily understood and put into practical effect, reference will now be made to embodiments of the present invention with reference to the accompanying drawings, wherein like reference numbers refer to identical elements. The drawings are provided by way of example only, wherein:

FIGS. 1A and 1B: show two different prior art valve monitors, the Amtron valve monitor (1A) and the Potter valve monitor (1B).

FIG. 2A: show one embodiment of a valve monitor according to the invention installed on a valve.

FIG. 2B: shows the components of a case according to one embodiment of the invention and an actuator according to one embodiment of the invention in a disassembled state;

FIG. 2C: shows one embodiment of a case according to the invention with two switches inserted.

FIG. 2D: shows the components of the embodiment of FIG. 2A in an assembled state.

FIG. 3A: shows a conventional or standard valve body.

FIG. 3B: shows a valve according to another embodiment of the invention in which the valve monitor is enclosed in the valve body.

FIG. 4: shows an exploded isometric view of another embodiment of a valve monitor according to the invention.

FIG. 5A: shows a partially exploded isometric view of yet another embodiment of a valve monitor according to the invention.

FIG. 5B: shows a section view of the valve monitor of FIG. 5A in the normal position.

FIG. 5C: shows a section view of the valve monitor of FIG. 5A in the alarm position.

Skilled addressees will appreciate that elements in the drawings are illustrated for simplicity and clarity and have not necessarily been drawn to scale. For example, the relative dimensions of some elements in the drawings may be distorted to help improve understanding of embodiments of the present invention.

TABLE OF PARTS

| | |
|---|---|
| 100, 300, 400 | monitor |
| 110, 310, 410 | actuator |
| 112, 312, 412 | actuator body |
| 114 | plate |
| 116 | protrusion |
| 118, 318, 418 | contact surface |
| 120, 420 | switch activator |
| 122 | column |
| 124 | activating surface |
| 126 | actuator locating component |
| 127, 327, 427 | bias |
| 128 | magnet |
| 129, 329, 429 | spring |
| 130 | one or more switch |
| 132 | wired connection |
| 140 | enclosure |
| 142 | complementary locating component |
| 144 | port |
| 146 | one or more seal |
| 150 | case |
| 152 | external wall |
| 154 | walled partition |
| 156 | partition wall |
| 158 | well |
| 160 | case fastener |
| 162 | case locator |
| 170 | lid |
| 172 | lid external wall |
| 174 | side wall |
| 176 | channel wall |
| 178 | lid shaft channel |
| 180 | lid fastener |
| 182 | lid locator |
| 190 | spacer |
| 192 | spacer body |
| 193 | spacer wall |
| 194 | columns |
| 196 | shaft channel |
| 198 | switch access passage |
| 199 | spacer locator |
| 200 | valve |
| 210 | valve body |
| 212 | yoke arms |
| 214 | valve body port |
| 216 | valve body channel |
| 220 | valve shaft |
| 222 | groove |
| 315 | bar |
| 402 | fastener |
| 417 | lever |
| 419 | cam surface |
| 421 | pin |

### DETAILED DESCRIPTION OF THE INVENTION

The invention relates to a gate valve monitor.

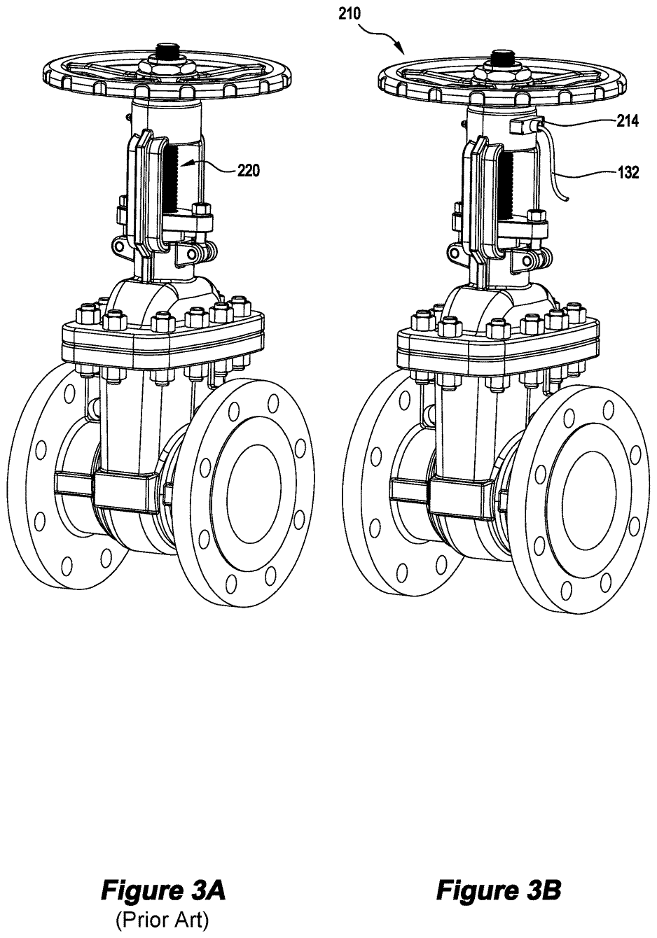

The invention is at least partly predicated on the unexpected discovery that an actuator for a gate valve monitor may be accommodated inside an enclosure. In one particular embodiment, the enclosure is the valve body. That is, the valve body may form the enclosure accommodating the one or more switch and an actuator. As will be elucidated below, with reference to FIGS. 3A and 3B, the valve body may be modified to include a valve body port 214 and valve body channel 216 (not shown).

While the invention will be described with reference to a fire protection system, specifically a fire sprinkler system, the invention is not so limited.

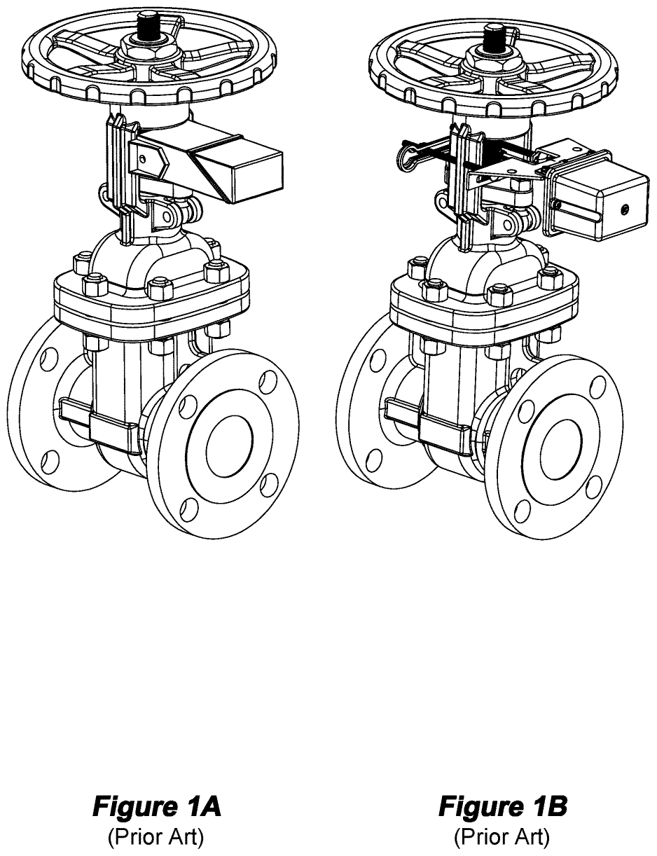

FIGS. 1A and 1B illustrate two conventional prior art gate valve monitors. FIG. 1A shows the Amtron gate valve monitor which requires drilling into both the gate valve shaft and the gate valve casing to install the magnetic actuator and the valve monitor body, respectively. The drilling, particularly of the stainless-steel gate valve shaft is difficult and can render the valve unusable if incorrectly performed. Also, drilling and riveting the valve invalidates the product approvals and certification for the valve.

The Potter gate valve monitor, shown in FIG. 1B requires fastening with a generic one-size-fits-all clamp so that the protruding lever actuator can ride on the valve shaft.

The inventor has surprisingly discovered that all current or conventional external or ‘bolt-on’ monitoring solutions suffer from a need to be perfectly aligned. This requirement is necessitated by the need for conventional external or ‘bolt-on’ monitoring solutions to have their means of ‘sensing’ the valve position to be easily accessible, which invites tampering. Advantageously, in one embodiment, the invention provides a gate valve monitor in which the sensing mechanism, that is the one or more switch and the actuator, are not easily accessible.

In a particular aspect, the invention relates to a gate valve monitor comprising an enclosure dimensioned to be wholly positioned within the valve body such as, the space between valve yoke arms, the space enclosing the handwheel nut, or the space within the valve bonnet cover. That is, no part of the enclosure extends outside the valve body. The inventor's provision of a gate valve monitor wholly positioned within the valve body is highly advantageous because the valve monitor is thereby protected from bumping or other external contact, which avoids triggering a false alarm. This advantage of the invention is highly desirable because these types of false alarm can not be reset at the fire panel and instead a technician must attend to replace the monitor or re-calibrate the monitor. Furthermore, fitting the gate valve monitor within the yoke arms naturally conceals the device, thereby deterring tampering.

A further advantage of the invention that occurs by avoiding these types of false alarms is that better compliance and better monitoring is achieved. This is because when the types of false alarm that are described above occurs, they are often viewed as “non-urgent” and/or “nuisance” alarms and they may be isolated at the fire alarm control panel permanently, or for an extended period of time. This results in no further supervision of what is commonly the fire protection system water supply valve.

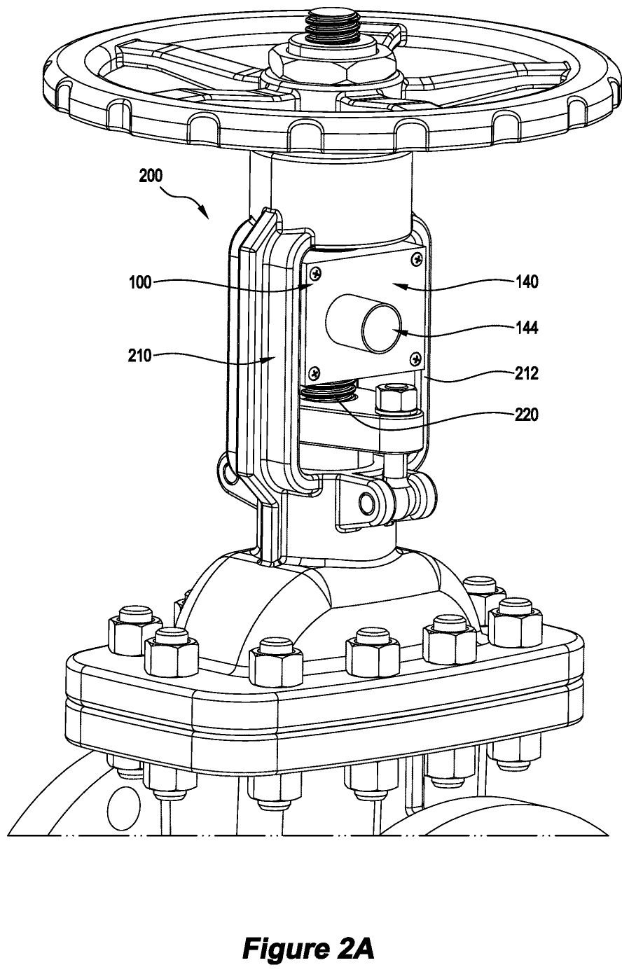

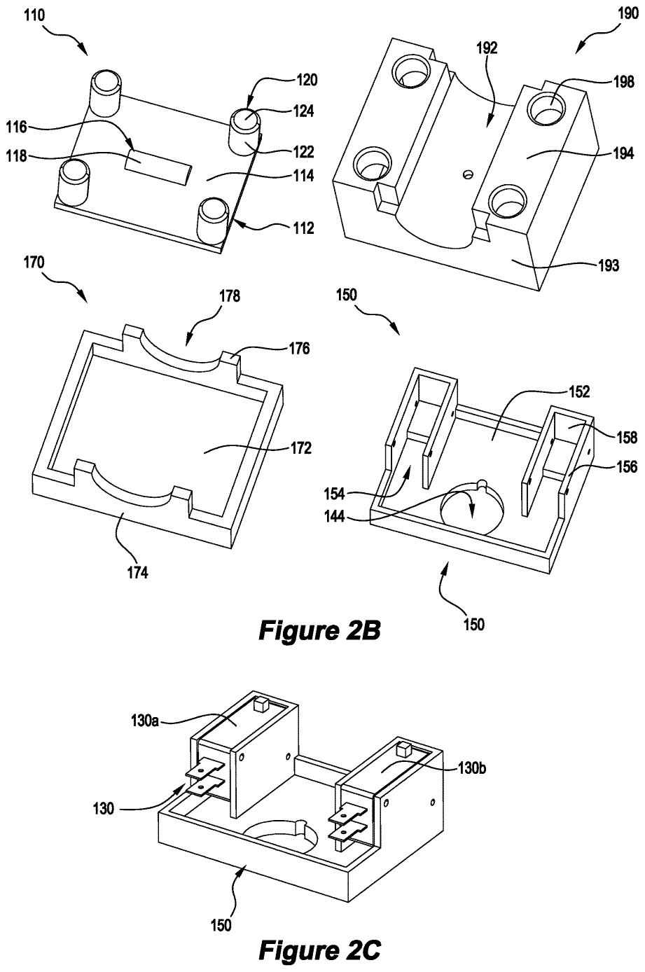

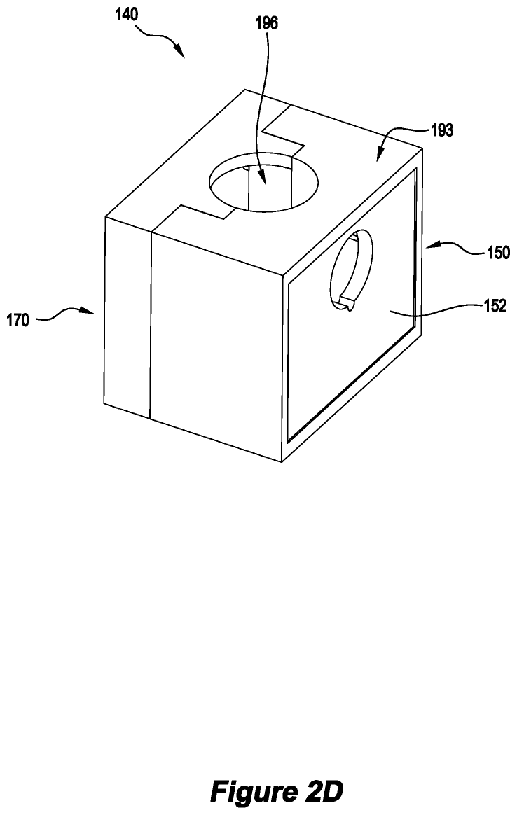

FIGS. 2A; 2B; 2C; and 2D shows one embodiment of a gate valve monitor 100 for monitoring gate valve 200. Monitor 100 is shown to comprise an enclosure 140 for accommodating one or more switch 130 and an actuator 110. Enclosure 140 is also dimensioned to allow passage of gate valve shaft 220.

The embodiment illustrated in FIGS. 2A: 2B; 2C; and 2D illustrate an enclosure 140 which is a separate component to valve body 210.

As will become clear from the below description, and FIGS. 2B; 2C; and 2D, actuator 110 is operated by movement of gate valve shaft 220 which triggers one or more switch 130.

Advantageously, actuator 110 is wholly accommodated within enclosure 140, such that in one embodiment no part of actuator 110 extends outside enclosure 140. This is achieved by enclosure 140 being dimensioned to be wholly positioned within valve body 210 by being dimensioned to fit within a space between valve yoke arms 212. From the teaching herein, the skilled person is readily able to adapt enclosure 140 so that is dimensioned to be wholly positioned within other areas of a valve body 210 or for other valve body shapes.

FIG. 2B shows the components of monitor 100 in a disassembled state. Actuator 110 can be seen, along with the two external case components, in the form of case 150 and lid 170. Also shown is spacer 190. Actuator 110 is shown to comprise a single integer or single component in the form of a single mechanical integer or mechanical component.

The two external case components 150, 170 join together with one or more fastener in the form of complementary fastening components, case fastener 160 (not shown) and a lid fastener 180 (not shown).

FIGS. 2B and 2C shows case 150 to comprise external wall 152 and one or more walled partition 154, formed by partition wall 156, for seating the one or more switch 130, in well 158 created by the partition wall 156. In another embodiment, a walled partition 154 may be disposed on lid 170. Although not shown, case 150 also comprises a case fastener 160.

As can be appreciated from FIG. 2C, one or more switch 130 is wholly located within enclosure 140. The two switches 130a,b illustrated in FIG. 2C comprise a normal state switch 130a triggered by actuator 110 in a normal state of monitor 100 and an alarm switch 130b which is triggered by actuator 110 in an alarm state. The normal state switch 130a and the alarm switch 130b are opposing sides of the enclosure 140.

Returning to FIG. 2B, lid 170 comprises lid external wall 172, from which extends side wall 174. In turn, channel walls 176 extend from side walls 174s, on opposing sides of the lid 170, to form lid shaft channel 178.

Although not shown, lid 170 comprises a lid fastener 180, which fastens to the complementary case fastener 160 to shut enclosure 140. Advantageously, shutting of the enclosure 140 with fasteners 160, 180 is a locking, or a one-way shutting such that, a tool is required to unlock or open enclosure 140. This prevents, or at least minimizes, any tampering or unauthorised access to monitor 100.

Returning again to FIG. 2B, enclosure 140 is also shown to comprise spacer 190, which in the assembled state, shown in FIG. 2D, is positioned between lid 170 and case 150. Spacer comprises spacer body 192 which comprises a spacer wall 193. Columns 194 extend on opposing sides of wall 193 to form shaft channel 196 (see FIG. 2D).

To allow access to the one or more switch 130, enclosure 140 comprises one or more switch access passage 198, which in the embodiment shown in FIG. 2B extend through spacer wall 193 and columns 194.

Although not shown, spacer 190 comprises a spacer locator 199 for interaction with one or both of a case locator 162 (not shown) and/or lid locator 182 (not shown). The interaction of the spacer locator 199 with one or both of the case locator 162 and/or the lid locator 180 may prevent or restrict relative movement.

Also not shown, one or more seal 146 may be comprised in enclosure 140, the seal may be in the form of an, an o-ring. The one or more seal 146 may prevent water or dirt entering the internal space of the enclosure 140 or valve body 210 and the one or more switch 130. The one or more seal 146 may seal the shaft channel 196 and/or the port 144, valve body port 214. Alternatively, the o-ring seal may be placed in a groove (not shown) in the column 124, sealing against the access passage 198, thereby preventing the ingress into the compartment enclosing the switches.

From the teaching herein, the skilled person is readily able to select other suitable seals such as, sealing tape, diaphragm, wiper etc.

In other embodiments, spacer 190 may be an integral component of the case 150 or lid 170.

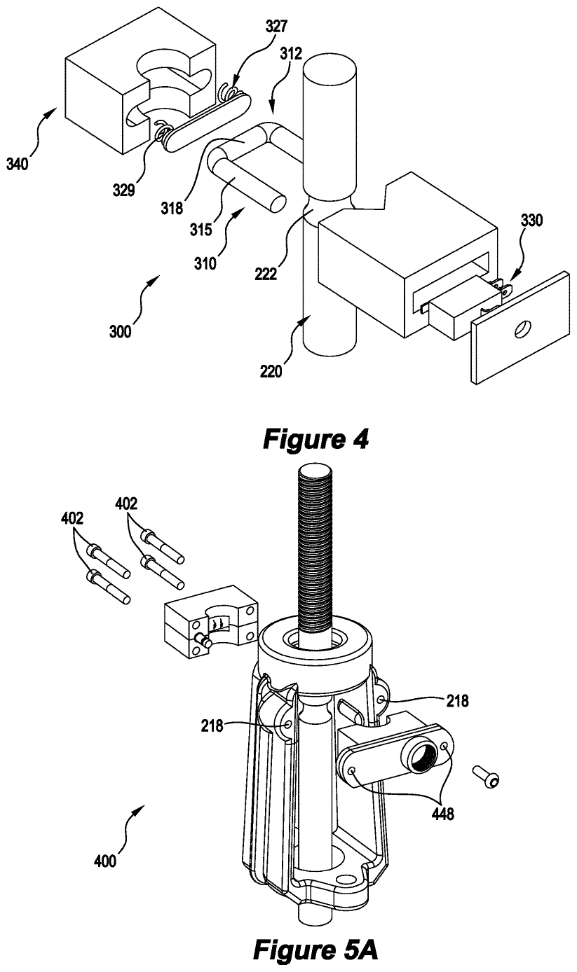

As shown in the embodiment of FIG. 2B, actuator 110 comprise a protrusion 116, having a contact surface 118, dimensioned to extend into a groove 222 (not shown) in said gate valve shaft. Protrusion 116 is shown disposed on actuator body 112, which is in the form of plate 114. The movement of gate valve shaft 220, up and down to open and close the gate valve means the groove 222 moves up and down, this movement impacts protrusion 116, which moves plate 114 to activate one or more switch 130. To facilitate this actuation, protrusion 116 comprises a shape complementary to groove 222. In the resting state, gate valve protrusion 116 sits in groove 222, and is continually pushed inward by a bias 127, in the form of a compression spring 129 (see springs 329 in FIG. 4) applied to the reverse side of the plate 114. The compression spring 129 also pushes against the underside of the lid 172. When valve shaft 220 slides to open or close gate valve 200, the valve shaft 220 physically impacts on curved or convex shaped contact surface 118 to overcome the bias 127 and move plate 114 such that switch activator 120, in the form of one or more columns 122, comprising activating surface 124, trigger one or more switch 130. When the gate valve 200 is moved back to the normal position the convex shaped contact surface 118 is pushed back into the groove 222 under pressure from the compression spring 129 acting on the reverse side of the plate 114.

Although not shown, the contact surface 118 may comprise a rolling element to reduce friction and load during movement.

That is, actuator 110 is directly operated by movement of gate valve 200 or gate valve shaft 220. The direct operation is a result of the physical impact of gate valve shaft 220 on actuator 110, specifically on the protrusion 116. Note that all fire protection gate valves utilize a groove 222 in the valve shaft.

The interaction of columns 122 and switch access passages 198 also serve to locate actuator 110 in position within enclosure 140. In other embodiments, actuator 110 comprises one or more actuator locating component 126 to interact with one or more complementary locating component 142 on enclosure 142.

When the actuator, enclosure 140, case 150, lid 170 and spacer 190 are assembled, as shown in FIG. 2D, the gate valve shaft 220 traverses an entire extent of enclosure 140 through the space created by shaft channel 196 and lid shaft channel 178.

Valve monitor 100 may comprise an anti-tamper functionality. The anti-tamper valve monitor 100 may comprise the one or more switch 130 being activated by an attempt to tamper with or attempt to access or remove the valve monitor 100. In the embodiment shown in FIGS. 2A; 2B; 2C; and 2D, this is achieved by separation or partial separation of lid 172 concomitantly resulting in separation or partial separation of actuator 110, which releases contact of the one or more switch 130 which automatically generates an alarm signal. As such, the typical routine testing of the alarm generation also tests the anti-tamper functionality. Accordingly, no secondary tamper switches are required.

While the one or more switch 130 comprises a terminal switch, from the teaching herein, a skilled person is readily able to select a suitable switch. In a particular embodiment, each one or more switch 130 is not a magnetic switch because, a magnetic switch may be tampered with using an external magnet.

To accommodate electrical cabling to supply one or more switch 130 the enclosure 140 comprises a port 144. While port 144 is shown to be comprised on case 150, in other embodiments port 144 may be comprised on lid 170. In other embodiments, monitor 100 may be wireless, comprising a wireless module and optionally one or both of: a battery and antenna.

FIG. 3B shows an example valve body 210 which has been modified to include a valve body port 214 and a valve body channel 216 (not shown) which advantageously allows a wired connection 132 to connect to a valve monitor 100 located within the valve body 210.

FIG. 3A is shown to allow comparison to a standard or conventional gate valve body.

The embodiment of FIG. 3B is advantageous in that valve body 210 serves as the enclosure containing the one or more switch 130 and the actuator 110.

FIG. 4 shows an exploded view of another embodiment of a gate valve monitor 300 in which actuator 310 has an actuator body 312 in the form of a bar 315. The contact surface 318 is disposed on the middle-section of the U-shaped bar 315.

From the exploded view of FIG. 4, it is readily apparent how movement of valve shaft 220 shunts actuator 310 out of groove 222 and against the biasing force applied by bias 327. In the embodiment of FIG. 4, like that of FIGS. 2A, 2B, 2C and 2D, bias 127 is provided in the form of springs 329.

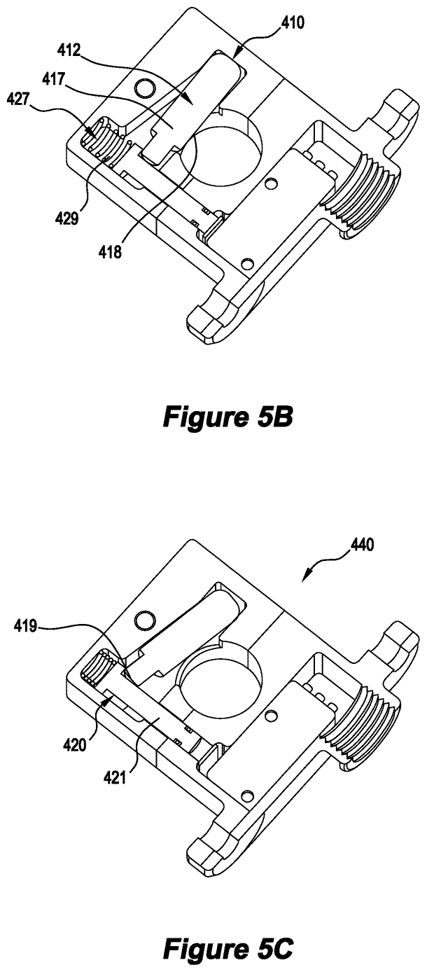

FIGS. 5A, 5B and 5C show another embodiment of a gate valve monitor 400, one in which enclosure 440 is mounted to the yoke arms 212 of valve body 210. As best illustrated in the partially exploded view of FIG. 5A, fasteners 402 secure gate valve monitor 400 to gate valve 200 by passing through valve body fastening holes 218 and enclosure fastening holes 448. As shown in FIG. 5A, valve body fastening holes 218 are disposed in yoke arms 212.

FIGS. 5B and 5C show section views of gate valve monitor 400 in a “normal position” and an “alarm position”, respectively. It is understood from a comparison of the “normal position” illustrated in FIG. 5B with the “alarm position” illustrated in FIG. 5C that with movement of shaft 220, actuator 410 is shunted out of groove 22 and against the biasing force applied by bias 427. Again, in the embodiment of FIGS. 5A, 5B and 5C, like the others herein, bias 127 is provided in the form of a spring 429.

The actuator 410 of the embodiment shown in FIGS. 5B and 5C is in the form of a lever 417, part of which comprises a contact surface 418 which protrudes into the groove 222. Movement of shaft 220 impacts lever 417 such that a cam surface 419, comprised on lever 417, acts on switch activator 420 in the form of a pin 421. As shown in FIGS. 5B and 5C, lever 417 is linear, with contact surface 418 disposed on a middle section.

The invention also provides a method of monitoring a gate valve comprising fitting or retrofitting gate valve monitor 100 to a gate valve 200. The fitting or retrofitting may comprise fastening the gate valve monitor 400 to the valve body 210 such as, by applying one or more fastener 402 to the yoke arms 212. The one or more fastener 402 may pass through one or more valve body fastening holes 218.

Further provided is a method of manufacturing gate valve monitor 100 comprising providing enclosure 140 and inserting the one or more switch 130 and actuator 110 into the enclosure.

A kit for monitoring a gate valve 200 is also comprised. The kit comprises enclosure 140, one or more switch 130 and actuator 110. In one embodiment, the kit comprises the fully assembled ‘halves’ of the monitor 100, that is the actuator 110; case 150; spacer 190 and lid 170 may be assembled into two halves and the installer simply needs to connects the halves together over the valve shaft 220 and fasten the two halves together. The kit may further comprise one or more fastener 402.

As will be understood by the skilled person, the invention also provides a method of monitoring a gate valve 200 comprising fitting or retrofitting valve monitor 100 to a gate valve 200 and a method of preventing unauthorised opening or closing of a gate valve 200 comprising fitting or retrofitting valve monitor 100 to the gate valve 200.

From the above description, it will be readily appreciated that valve 100 has many advantages, including that it can not be as easily defeated as the prior art valves. For example, a handheld magnet may be used to defeat the Amtron valve, while the protruding lever of the Potter valve may be easily manipulated to isolate the lever.

The present invention is of improved security as the gate valve monitor 100 sits within an enclosure or the valve body 200 when fitted. The operation is simple, with the alarm triggered directly by movement of the valve shaft 220, so that when the relative position of the groove 222 on the shaft 220 moves, this triggers the one or more switch 130. With the sensing elements enclosed, the gate valve monitor 100 of the invention is not subject to tampering and eliminates the chance of any “false open”. Also, any attempt to remove the gate valve monitor 100 will trigger the alarm.

Further advantages of monitor 100 include that there is no requirement for tamper proof fasteners. This is because separating the two housing parts 150, 170 or removing monitor 100 will generate the alarm. Additionally, there is an absence of accessible seams, way to defeat the monitor 100, or means to gain access to manipulate one or more switch 130. Moreover, the simple mechanical actuation makes false alarms unlikely.

Gate valve monitor 100 provides a genuine tamper proof gate valve monitor which is cost effective and may be quickly and easily installed, without any drilling or modification. The simple installation means there is no risk of invalidating any approval and no risk of false alarms or call out fees resulting from the installation. A further advantage is that because the installation may be performed easily on-site or in situ, there is no need to first ship the valve 200 to have the monitor 100 fitted. Also, with monitor 100 may be easily retrofitted to valves already in service.

Another advantage is that by increasing the anti-tamper protection to Class A monitoring, a reduction in insurance premiums may be achieved. Additionally, the improvement to Class A may reduce the frequency of legislated routine testing and inspection with significant ongoing cost savings.

In this specification, the terms “comprises”, “comprising” or similar terms are intended to mean a non-exclusive inclusion, such that an apparatus that comprises a list of elements does not include those elements solely, but may well include other elements not listed.

Throughout the specification the aim has been to describe the invention without limiting the invention to any one embodiment or specific collection of features. Persons skilled in the relevant art may realize variations from the specific embodiments that will nonetheless fall within the scope of the invention.

1. A gate valve monitor comprising:
one or more alarm switch and an actuator, the one or more alarm switch and the actuator accommodated within an enclosure, the enclosure dimensioned to allow passage of a gate valve shaft traversing an entire extent of the enclosure, the actuator comprising an actuator body dimensioned to extend into a groove in the gate valve shaft; and
the actuator operated by movement of the gate valve shaft which impacts the actuator body to trigger the one or more alarm switch.

2. A gate valve comprising the gate valve monitor of claim 1.

3. A method of monitoring a gate valve, the method comprising:
fitting or retrofitting a gate valve monitor to a gate valve, the gate valve monitor comprising one or more alarm switch and an actuator, the one or more alarm switch and the actuator accommodated within an enclosure the enclosure dimensioned to allow passage of a gate valve shaft traversing an entire extent of the enclosure, the actuator comprising an actuator body dimensioned to extend into a groove in the gate valve shaft, wherein the actuator is operated when the gate valve shaft moves which impacts the protrusion to trigger the one or more alarm switch.

4. A method of manufacturing a gate valve monitor, the method comprising:
providing one or more alarm switch and an actuator to be accommodated within an enclosure, the enclosure dimensioned to allow passage of said gate valve shaft traversing an entire extent of the enclosure, the actuator comprising an actuator body dimensioned to extend into a groove in the gate valve shaft; and
inserting the one or more alarm switch and the actuator into the enclosure, wherein the actuator is operated by movement of the gate valve shaft which impacts the actuator body to trigger the one or more alarm switch.

5. A kit for monitoring a gate valve, the kit comprising:
an enclosure, one or more alarm switch and an actuator, the one or more alarm switch and the actuator to be accommodated within the enclosure, the enclosure dimensioned to allow passage of said gate valve shaft traversing an entire extent of the enclosure, the actuator comprising an actuator body dimensioned to extend into a groove in the gate valve shaft;
wherein the actuator is operated by movement of the gate valve shaft which impacts the actuator body to trigger the one or more alarm switch.

6. A method of monitoring a gate valve, the method comprising fitting or retrofitting the valve monitor of claim 1 to the gate valve.

7. A method of preventing unauthorised opening or closing of a gate valve, the method comprising fitting or retrofitting the valve monitor of claim 1 to the gate valve.

8. The gate valve monitor according to claim 1 wherein the one or more alarm switch and the actuator are dimensioned to be accommodated with the enclosure.

9. The gate valve monitor according to claim 1 wherein the enclosure is a valve body.

10. The gate-valve monitor according to claim 1 wherein the enclosure is a separate component to a valve body.

11. The gate-valve monitor according to claim 1 wherein the actuator is accommodated within the enclosure.

12. The gate-valve monitor according to claim 1 wherein the actuator comprises a single integer or single component.

13. The gate-valve monitor according to claim 1 wherein the enclosure is dimensioned to be wholly positioned within a valve body.

14. The gate-valve monitor according to claim 1 wherein the one or more alarm switch is activated by unauthorized opening or closing of a gate valve or attempted removal of the valve monitor.

15. The gate-valve monitor according to claim 1 wherein movement of the gate valve shaft and impact on the actuator body moves the actuator body to activate the one or more alarm switch.

16. The gate-valve monitor according to claim 1 wherein the actuator comprises a bias.

17. The gate-valve monitor according to claim 1 wherein the enclosure comprises a port to accommodate cabling to supply power or receive an alarm signal from the gate valve monitor.

18. The gate-valve monitor according to claim 1 comprising a wireless module, battery and antenna incorporated within the enclosure to provide anti-tamper protection.

19. The gate-valve monitor according to claim 1 wherein the gate valve monitor comprises an anti-tamper valve monitor.

20. The gate-valve monitor according to claim 19 wherein the anti-tamper valve monitor comprises the one or more alarm switch being activated by an attempt to tamper with or attempt to access or remove the valve monitor.

21-23. (canceled)
